(19) United States
(12) Patent Application Publication
(10) Pub. No.: US 2024/0082873 A1
(43) Pub. Date: Mar. 14, 2024

(54) LEAN THERMOFORM TRAY

(71) Applicant: Magna Exteriors Inc., Aurora (CA)

(72) Inventors: Gouthaman Nithyanand, Smyrna, GA (US); Charl Coetser, Villa Rica, GA (US); Blake McCormick, Carrollton, GA (US)

(73) Assignee: Magna Exteriors Inc., Aurora, ON (CA)

(21) Appl. No.: 18/463,403

(22) Filed: Sep. 8, 2023

Related U.S. Application Data
(60) Provisional application No. 63/405,168, filed on Sep. 9, 2022.

(51) Int. Cl. B05C 21/00; B65D 1/36; B65D 21/02

(52) U.S. Cl. CPC B05C 21/005; B65D 1/36; B65D 21/0209

(57) ABSTRACT

A stackable paintable moveable multi-purpose parts tray comprising at least one parts holding location for securing a part to be processed in a multistep process including painting of the part and other downstream processing of the part. A process for multi-processing of a part comprising the steps of: A. Providing a stackable paintable moveable multi-purpose parts tray comprising at least one parts holding location for securing a part to be processed; B. Placing the part to be subjected to a plurality of processes in the tray; and C. Subjecting the part to at least one process including painting the part while it remains in the tray.

### CROSS-REFERENCE TO RELATED APPLICATIONS

This application is a Non-Provisional Patent Application and claims benefit of U.S. Provisional Patent Application No. 63/405,168, filed Sep. 9, 2022. The disclosure of the above application is incorporated herein by reference.

### FIELD OF THE INVENTION

The present invention relates to a lean thermoform tray.

### BACKGROUND OF THE INVENTION

In the past thermoforming parts, transporting parts, painting parts, and assembling parts have required several different transfers of the parts from holding trays to painting trays where masking of areas other than the parts is often required. The parts are then painted and then repackaged to be sent for final assembly in a vehicle for instance. This is time consuming and expensive.

Therefore, it is desirable to provide a tray that can hold the part through an entire processing cycle without repackaging or masking for paint. Such a tray would act as a fixture to carry parts from point of origin—through the value addition streams—up until assembly.

### SUMMARY OF THE INVENTION

A stackable paintable moveable multi-purpose parts tray comprising at least one parts holding location for securing a part to be processed in a multistep process including painting of the part and other downstream processing of the part. A process for multi-processing of a part comprising the steps of:
A. Providing a stackable paintable moveable multi-purpose parts tray comprising at least one parts holding location for securing a part to be processed;
B. Placing the part to be subjected to a plurality of processes in the tray; and,
C. Subjecting the part to at least one process including painting the part while it remains in the tray.

The trays are thermoformed using a high molecular weight polyethylene (HMWPE) material. Each tray can hold 48 parts (SAP brackets). The trays are stackable. Each tray has a lid that secures parts in place as well as acts as a masking feature to prevent overspray of paint. This tray acts as a fixture to carry parts from point of origin —through the value addition streams—up until assembly.

The tray of the present invention is used as a packaging tray, plus transit between facilities, plus paint-line carrier, plus line-side parts holder at assembly. This tray eliminates the need to mask parts as it prevents overspray with the use of lids. Tray can be re-used up to an estimated 30-35 rounds of paint cycles. It eliminates several non-value adding steps along the process cycle in terms of handling of parts, masking, de-masking, and kitting.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top perspective view of a multi-purpose part tray in accordance with the present invention;

FIG. 2 is a top perspective view of a multi-process part tray in accordance with the present invention showing the transporting and painting mask lid in place;

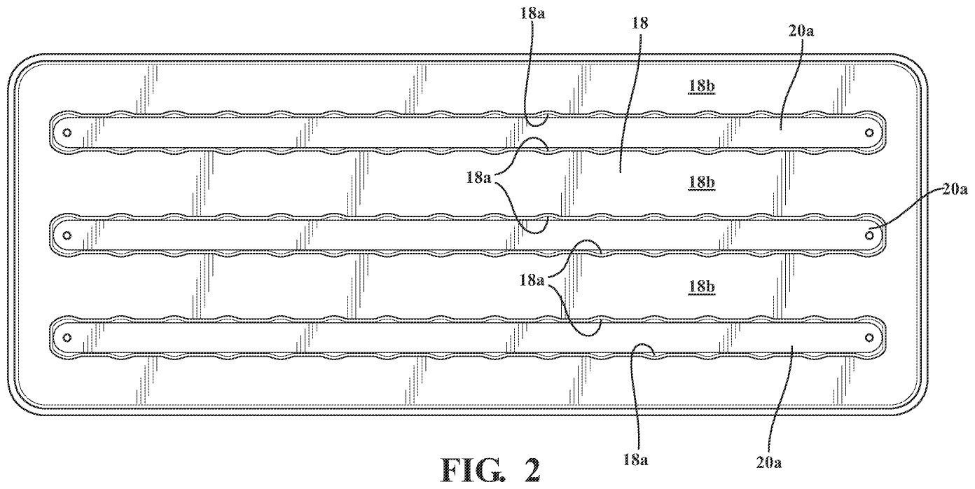

FIG. 3 is a detailed perspective view of the multi-process part tray of the present invention; and,

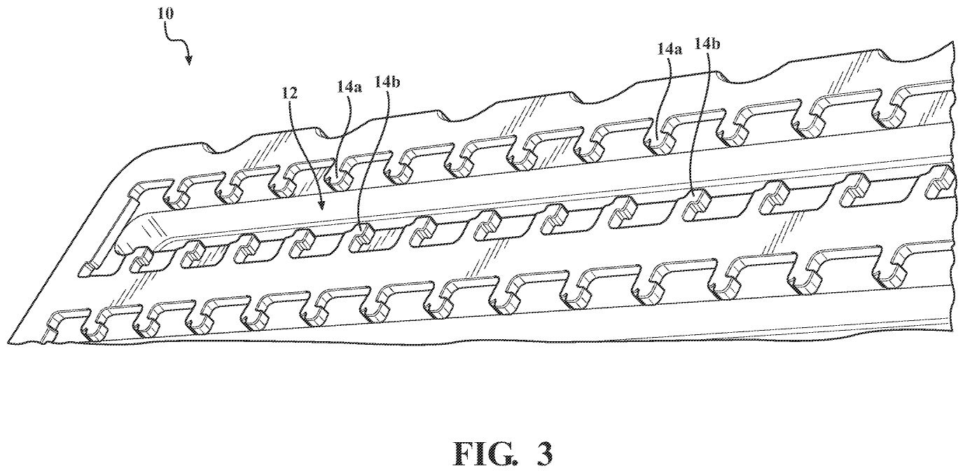

FIG. 4 is a flow diagram showing the process flow of the parts from start to finish using a single multi-purpose part tray of the present invention.

### DETAILED DESCRIPTION OF THE PREFERRED EMBODIMENTS

The following description of the preferred embodiment(s) is merely exemplary in nature and is in no way intended to limit the invention, its application, or uses.

The trays are thermoformed using HMWPE material. Each tray can hold 48 parts (SAP brackets). The trays are stackable. Each tray has a lid that secures parts in place as well as acts as a masking feature to prevent overspray of paint. This tray acts as a fixture to carry parts from point of origin—through the value addition streams—up until assembly.

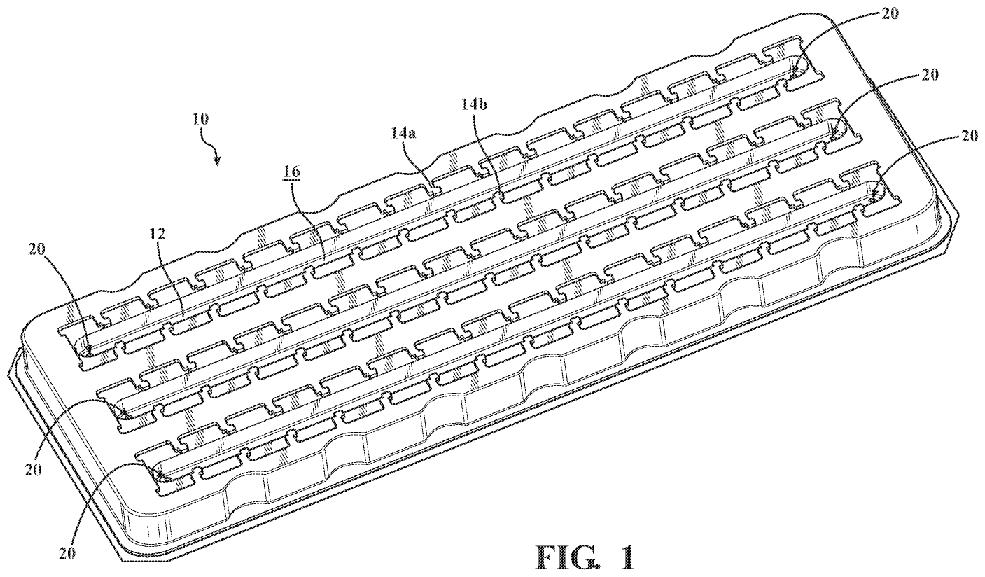

In accordance with the present invention there is provided a stackable paintable moveable multi-purpose parts tray generally shown at 10. The tray 10 includes at least one parts holding location 12 for securing a part (not shown) to be processed in a multistep process including painting of the part and other downstream processing of the part, as shown in FIG. 1. Typically, the tray includes a plurality of parts holding locations 12. These are designed by a suitable spacing and securement arm 14a and 14b which are designed to hold the part in the tray and in the slot 16.

A top 18 is provided for engaging and securing the parts. The top 18 is a paint mask cover which allows the parts inside to be painted by way of paint orifices 20 which allow paint to be injected into the parts holding area and along channels 20a to paint the parts held in the tray while they are secured in the tray. Paint mask cover member 18 fits over and engages the parts tray for painting of the part while the part is secured in the parts tray. The paint mask cover member includes paint channels 18a and masking areas 18b. The paint channels 18a allow paint which is injected and move along the channels 18a for painting of parts while the masking areas 18b cover areas of the parts where paint is not desirable. The masking cover can be a specialized cover or the stackable trays themselves are designed and utilized to provide a masking cover for the tray below them and a parts holding tray on their upper surface. Using this system paint is substantially contained and conserved in the part holding locations.

The tray is molded to house a plurality of parts for paint processing in a single tray. The tray is molded via injection molding, compression molding, rotocast molding or the like preferably from high molecular weight polyethylene. However other materials which are structurally sound and relatively inert to paint and paint solvents and the like can also be used.

In accordance with the process aspects of the present invention, the tray 10 and paint mask cover member 18 provide a storage, transport, paint processing and assembly line solution for a plurality of parts which are held in the tray 10. In accordance with the broad aspects of the process the steps include:
A. Providing a stackable paintable moveable multi-purpose parts tray with at least one parts holding location for securing a part to be processed;
B. Placing the part to be subjected to a plurality of processes in the tray; and,
C. Subjecting the part to at least one process including painting the part while it remains in the tray.

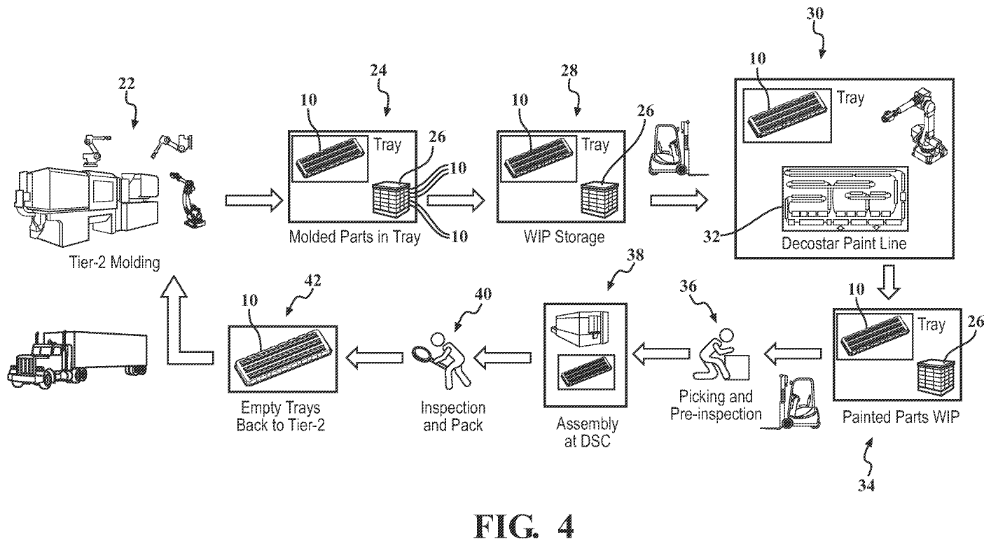

Referring now to FIG. 4 of the drawings is shown a typical process using the tray 10 of the present invention. The parts to be fit in a predetermined tray are first molded into the final part shown at step 22. Thereafter the parts are placed in the tray 10 with the paint mask lids 18 installed in step 24. The trays with covers installed are stackable into a movable container pallet 26. The parts are then suitable for storage at step 28. As needed for manufacture the stored trays of parts 26 are moved to a paint line at step 30 where the trays are removed from the pallet container arrangement 26 and placed on the paint line 32 where the parts are painted while still in the tray 10 with the paint mask lid 18 attached. Next the painted parts are placed back in the pallet container arrangement and are suitable for storage or further transportation at step 34. The parts are suitable for preassembly inspection at step 36 and are thereafter used for manufacturing assembly at step 38. Thereafter, the trays are inspected to be reused at step 40 and are reused back at the molding location and step 42.

Thus, in operation one tray predesigned to hold a preselected part is used as a packaging tray, plus transit between facilities, plus paint-line carrier, plus line-side parts holder at assembly. This tray eliminates the need to mask parts as it prevents overspray with the use of lids 18. Tray 10 can be reused up to an estimated 30-35 rounds of paint cycles. It eliminates several non-value adding steps along the process cycle in terms of handling of parts, masking, de-masking and kitting.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A stackable paintable moveable multi-purpose parts tray comprising:
at least one parts holding location for securing a part to be processed in a multistep process including painting of the part and other downstream processing of the part.

2. The stackable paintable moveable multi-purpose parts tray of claim 1 wherein a paint mask cover member is provided which fits over and engages the parts tray for painting of the part while the part is secured in the parts tray.

3. The stackable paintable moveable multi-purpose parts tray of claim 1 wherein the tray is molded to house a plurality of parts for processing in a single tray.

4. The stackable paintable moveable multi-purpose parts tray of claim 3 wherein the tray is molded from high molecular weight polyethylene.

5. A stackable paintable moveable multi-purpose parts tray comprising:
at least one parts holding location for securing a part to be processed in a multistep process including painting of the part and other downstream processing of the part, said parts holding location including a paint orifice for allowing paint to be injected into the part holding location for painting of the parts;
a masking cover which is adapted for placement over the tray, said masking cover having a paint channel for distributing paint to a part contained in the tray and a masking area which masks off areas of the part not to be painted.

6. The stackable paintable moveable multi-purpose parts tray of claim 5 wherein the masking cover further comprises a separate cover which fits over and engages the parts tray for painting of the part while the part is secured in the parts tray.

7. The stackable paintable moveable multi-purpose parts tray of claim 5 wherein the masking cover further comprises the bottom of another of said multi-purpose parts tray which fits over and engages the parts tray for painting of the part while the part is secured in the parts tray.

8. The stackable paintable moveable multi-purpose parts tray of claim 5 wherein the tray is molded to house a plurality of parts for processing in a single tray.

9. The stackable paintable moveable multi-purpose parts tray of claim 5 wherein the tray is molded from high molecular weight polyethylene.

10. A process for multi-processing of a part comprising the steps of:
A. Providing a stackable paintable moveable multi-purpose parts tray comprising at least one parts holding location for securing a part to be processed;
B. Placing the part to be subjected to a plurality of processes in the tray; and,
C. Subjecting the part to at least one process including painting the part while it remains in the tray.

11. The process of claim 10 wherein a masking cover is provided which is adapted for placement over the tray, said masking cover having a paint channel for distributing paint to a part contained in the tray and a masking area which masks off areas of the part not to be painted.

12. The process of claim 11 wherein the masking cover further comprises a separate cover which fits over and engages the parts tray for painting of the part while the part is secured in the parts tray.

13. The process of claim 11 wherein the masking cover further comprises the bottom of another of said multi-purpose parts tray which fits over and engages the parts tray for painting of the part while the part is secured in the parts tray.

14. The process of claim 11 wherein the tray is molded to house a plurality of parts for processing in a single tray.

15. The process of claim 11 wherein the tray is molded from high molecular weight polyethylene.
